(19) United States
(12) Patent Application Publication
(10) Pub. No.: US 2020/0069112 A1
(43) Pub. Date: Mar. 5, 2020

(54) ELECTRIC GRILL WITH TWO GRILL PLATES THAT DEFINE A GRILLING SPACE

(71) Applicant: Vorwerk & Co. Interholding GmbH, Wuppertal (DE)

(72) Inventors: Thomas BUENING, Bochum (DE); Martin HELMICH, Duisburg (DE)

(73) Assignee: Vorwerk & Co. Interholding GmbH, Wuppertal (DE)

(21) Appl. No.: 16/556,372

(22) Filed: Aug. 30, 2019

(30) Foreign Application Priority Data
Aug. 31, 2018 (EP) 18191930.9

(51) Int. Cl. A47J 37/06; A47J 27/00

(52) U.S. Cl. CPC A47J 37/0611; A47J 2037/0617; A47J 27/004; A47J 27/002

(57) ABSTRACT

An electric grill has two grill plates, which lie opposite of one another referred to their large plate surfaces and jointly define a grilling space, wherein the grill comprises a first grill plate for supporting grillables and a second grill plate that can be displaced relative to the first grill plate. A plate base that holds the grill plate is assigned to each grill plate, and at least one grill plate comprises at least one plate segment, which is displaceably held on the plate base and can be automatically displaced relative to the plate base holding this plate segment depending on a size and/or shape of a grillable introduced into the grilling space. In order to adapt the grilling space to grillables of different sizes, it is proposed that the grill plate comprises multiple plate segments, which can be displaced relative to one another and relative to the plate base.

### CROSS REFERENCE TO RELATED APPLICATIONS

Applicant claims priority under 35 U.S.C. § 119 of European Application No. 18191930.9 filed Aug. 31, 2018, the disclosure of which is incorporated by reference.

### BACKGROUND OF THE INVENTION

### 1. Field of the Invention

The invention pertains to an electric grill with two grill plates, which lie opposite of one another with respect to their large plate surfaces and jointly define a grilling space, wherein the grill comprises a first grill plate for supporting grillables and a second grill plate that can be displaced relative to the first grill plate, wherein a plate base that holds the grill plate is assigned to each grill plate, and wherein at least one grill plate comprises at least one plate segment, which is displaceably held on the plate base and can be automatically displaced relative to the plate base holding this plate segment depending on a size and/or shape of a grillable introduced into the grilling space.

### 2. The Prior Art

Electric grills of the aforementioned type are known from the prior art. These grills are frequently also referred to as contact grills because the grillables are contacted and cooked by the grill plates on two opposite sides. In most cases, one of the two grill plates, preferably the upper grill plate in a normal operating state, can be displaced relative to the other grill plate, for example, analogous to sandwich toasters, waffle irons or the like.

U.S. Pat. No. 3,746,837 discloses a heating device for foods with two opposite grill plates, which respectively comprise a plate segment that can be displaced relative to the associated plate base. The respective grill plate therefore consists of a single plate segment.

For example, U.S. Design Pat. No. D697,360 discloses an electric grill with two opposite grill plates, which are respectively held by a plate base. The two plate bases can be displaced relative to one another by means of a hinge.

Grills of this type have the disadvantage that the use of grillables with different heights within the grilling space leads to a different cooking result, for example such that a first grillable already is thoroughly cooked while a second grillable is only partially cooked. If the upper grill plate is pressed on with excessive force, for example, in order to compensate a height difference between multiple grillables to be cooked simultaneously, a deformation of the respective taller grillable can occur and likewise affect the cooking result. In addition, this force of pressure can cause the grillables to stick on the grill plates.

### SUMMARY OF THE INVENTION

Based on the aforementioned prior art, the invention aims to develop an electric grill, in which individual grillables, as well as grillables with different thicknesses, can be optimally grilled.

In order to attain the above-defined objective, the invention proposes that the grill plate comprises multiple plate segments that can be displaced relative to one another and relative to the respectively associated plate base.

This inventive design is particularly advantageous because multiple regions of a grill plate can be adapted to the thickness of a grillable lying on the grill. It is therefore also possible, for example, to optimally prepare more than two grillables with different heights in the electric grill, wherein each plate segment can be adjusted to an optimal plate height automatically and independently of adjacent plate segments such that the opposite plate segments optimally rest against the grillable lying in between. The resulting function corresponds to the function of a 3D pin board with a plurality of segments that recede when a force is applied thereto. It basically suffices if only one of the grill plates comprises such displaceable plate segments. However, it is also possible that both opposite grill plates comprise displaceable plate segments. According to an embodiment, only the upper grill plate of the electric grill may be realized in a segmented manner such that the height of the grilling space, i.e. the internal opening height, can be varied over part of the surface or the entire surface. The lower grill plate may likewise be realized in a segmented manner, but this is not absolutely necessary as already mentioned above. In a closed state of the grilling space, the opposite plate segments preferably rest in a frame of the plate base such that the electric grill can also be opened with only a single hand movement if the grill plate is segmented.

The height of at least a portion of a grill plate can be adapted to the height of a grillable to be cooked. In this context, it is possible, for example, that one grill plate comprises a plate segment that is arranged stationary relative to the plate base and a plate segment that is displaceably held on the plate base. Furthermore, another grill plate, which is formed by a single plate segment, can be displaced relative to the plate base as a whole such that the height of the plate segment can be adapted in such a way that the grilling space is always optimally closed when a relatively thin grillable is placed on the grill plate and when a thicker grillable is placed on the grill plate. In an embodiment, in which a first plate segment can be displaced relative to a second plate segment, it is advantageously accomplished that multiple grillables located in the grilling space are held flush and preferably with a homogenously applied pressure of the grill plate.

The plate base may be realized in a cup-shaped manner, wherein the plate segment can be at least partially displaced into the plate base. The term cup-shaped refers to shapes, which define three-dimensional spaces that are open on one side. Due to this design, a portion of the grill plate can protrude into the plate base and another portion can optionally protrude over an opening plane of the grill plate base, namely in the direction of the respective opposite grill plate or plate base. The plate base preferably can serve for guiding one or more displaceable plate segments. It would also be possible, in particular, that an inner edge region of the plate base provides guides for the displacement motion of a plate segment. It would furthermore be possible that a plate segment or multiple plate segments protrude over an edge of the cup-shaped grill plate base in an open position of the grilling space and are displaced into the associated plate base due to the closing process, i.e. when the opposite plate bases are moved toward one another. This may either be caused by the contact between the opposite grill plates or between one or more plate segments and a grillable. The grilling space preferably is closed by the abutting grill plate bases and/or grill plates in such a way that liquids escaping from the grillables can be collected and purposefully drained off and that an optimal temperature for the cooking process can be provided.

It is furthermore proposed that a resetting element is assigned to the plate segment and elastically supports the plate segment on the plate base. For example, a spring element, which is tensioned by an applied force, may be assigned to each plate segment. When a grillable, which prevents a defined closed position of the grilling space or protrudes over the planes of other grillables, is located between the grill plates, for example, the plate segment is displaced against the restoring force of the spring element until the applied force decreases because the protrusion of the respective grillable is eliminated. The spring elements may be realized, for example, in the form of coil springs, leaf springs or similar spring elements. It is furthermore also possible to support the plate segment on a body consisting of an elastic material or to manufacture the plate segment itself of an elastic material. The elastic support of the plate segments, i.e. the application of a prestressing force on the plate segments, ensures that the plate segments are displaced back into a forward starting position when no force is any longer applied to the plate segments, i.e. when the grilling space is opened and/or when no grillable rests against the respective plate segment and/or when the grillables placed on the grill have identical thicknesses, such that the grill plates rest against the grillables in an identical horizontal plane when the grilling space is closed.

It would furthermore be possible that a plate segment of the second grill plate can be displaced relative to the associated plate base due to a gravitational force acting upon the plate segment. For example, the second grill plate, i.e. the upper grill plate, therefore may alternatively or additionally to a reset of the plate segments by a spring element also comprise plate segments, which are supported on the plate base in such a way that they drop down due to the gravitational force when the grill plate is essentially oriented horizontally, i.e. when the plate segments within the plate base point vertically downward. Based on an open position of the grilling space, a premature horizontal position of the upper grill plate can be achieved with a hinge solution between the two plate bases, in which the plate bases are not only connected to one another by means of a single hinge pin, but which rather comprises a lever with two different hinge pins such that the upper grill plate can be prematurely or constantly aligned parallel to the lower plate base regardless of a current position during a closing process. In comparison with a connection with only a single hinge pin, such a closing mechanism is also advantageous because the grillables located in the grilling space are not initially compressed on one side, i.e. from the side of the hinge. In fact, the pressure of the upper grill plate can be homogenously applied to the grillables.

It is proposed that a plate segment provides a contact surface for grillables, the surface area of which amounts to 1 mm² to 1000 cm², particularly 20 mm² to 200 cm². The grill plate may therefore comprise a plurality of needle-shaped plate segments, which lie adjacent to one another like in a pin board and press against the grillables. The grill plate may alternatively or additionally also comprise plate segments, which are suitable for accommodating grillables with a customary surface area, for example pieces of meat, vegetables and the like, completely and without cooperation of adjacent plate segments. Depending on the chosen size of the individual plate segment, the grill plate may be realized in such a way that it adapts itself to a surface contour of a grillable with a plurality of plate segments and the surface of the respective grill plate therefore can be optimally used for supporting grillables. The plate segments of a grill plate particularly may also have different sizes such that there may be surface regions with larger or smaller plate segments than other surface regions. Consequently, a portion of the grill plate can be used for supporting large grillables while other plate segments are advantageous for supporting comparatively smaller grillables. The indicated surface areas for the plate segments represent preferred values, wherein a value of 1 mm² represents a customary surface area of needle points such that the contour of a grillable can be reproduced in a particularly precise manner. In contrast, the indicated surface areas of up to about 1000 cm² represent larger portions of a grill plate, which are realized in the form of a single plate segment. In one example, the grill plate may also be displaceable relative to the associated plate base as a whole, i.e. in the form of a single plate segment. Depending on the size of the grillable lying on the grill, the grill plate preferably can be retracted into a cup-shaped plate base as a whole in order to make it possible to close the grilling space in a flush manner. Preferred surface areas of a plate segment lie between 20 mm² and 200 cm², wherein these values approximately correspond to the surface areas of customary grillables such as pieces of meat, pieces of vegetables or the like.

In this context, it would also be possible that a grill plate comprises one to one thousand plate segments. The grill plate particularly may comprise two to one hundred plate segments, preferably two to ten plate segments. Depending on the size of the electric grill and the number of plate segments per grill plate, this also leads to different surface areas of the plate segments. The number of plate segments and their size particularly have to be adapted to one another, wherein the above-described embodiments, in which different surface regions of a grill plate comprise different sizes and different numbers of plate segments, can be realized.

It would be possible that a grill plate comprises at least two plate segments, wherein a separate heating device is assigned to each of the two plate segments, and wherein the heating devices of the plate segments can be controlled independently of one another with respect to an operating state and/or a heating power and/or a heating time. Due to this design, the temperature of a plate segment can be adjusted individually and independently of the temperature of other plate segments. For example, a heating element that can be individually energized may be assigned to each plate segment or a group of multiple plate segments. In this way, different heating powers and/or different temperature profiles and therefore also different cooking points of different grillables can be taken into account. It is particularly preferred that the plate segments of the first grill plate, as well as the plate segments of the second grill plate, can be heated independently of one another. This concerns, for example, their operating state, i.e. for example a current on/off state, a heating power or a heating time allotted for a grillable with a certain thickness. The heating device of a plate segment can be manually controlled by a user, for example, in that certain surface regions of the grill plate are activated by the user while other surface regions, which are not required due to the quantity and size of the grillables, remain deactivated. Alternatively, a heating device may also be controlled in an automated manner, for example, by means of a contact sensor and/or a weighing device that respectively measure or estimate the presence and/or a weight and/or a volume and/or a size of the grillables.

In this context, it is proposed that a sensor for detecting a displacement or a state of displacement of the plate segment or for detecting the presence of grillables on a contact surface of the plate segment is assigned to a plate segment. In a simple example, the sensor may be realized in the form of a contact sensor that determines the presence of grillables on the respective plate segment upon detection of a contact. Furthermore, the sensor may also detect a displacement, i.e. a changing height of the plate segment relative to the plate base, a displacement motion, for example by means of an acceleration sensor, a changing resistance or the like.

It is furthermore particularly advantageous if the electric grill comprises a control device that is designed for controlling a heating device assigned to a plate segment in dependence on a detection result of the sensor. According to this embodiment, the control device activates the heating device, which is assigned to one or more currently required plate segments. Plate segments, on which no grillables are currently positioned, remain deactivated. This reduces the power consumption for the operation of the electric grill. In addition, the control device can also determine the height of grillables placed on the grill, for example, by determining a distance between opposite plate segments of the grilling space. In order to adjust a heating power or an anticipated heating time, the control device may furthermore take into account information on the type of a grillable, its cooking point or the like such that different grillables reach an optimal cooking point at the same time and therefore can be served simultaneously. A user can optionally transmit information on the type of grillable and/or its weight or the like to the control device. Furthermore, the control device may also control a heat-retaining function or a waiting mode, which is activated once cooking of a grillable is completed. For example, grillables can thereby be kept warm until other dishes are finished.

It is ultimately proposed that one of the grill plates protrudes over the other grill plate and/or plate base with an edge region in the closed state of the grilling space such that liquid present in the grilling space can drain off. It would be possible that the first grill plate, i.e. the lower grill plate, protrudes over the second, upper grill plate. The protruding grill plate serves for optimally draining off liquid from the grilling space. A gap between the grill plates is formed due to the protrusion of one of the grill plates. A collection container, into which the liquid is correspondingly transferred, may be assigned to this gap.

### BRIEF DESCRIPTION OF THE DRAWINGS

The invention is described in greater detail below with reference to exemplary embodiments. In the drawings:

FIG. 1 shows an inventive grill according to a first embodiment,

FIG. 2 shows a top view of the grill in a closed state,

FIG. 3 shows a section through the closed grill,

FIG. 4 shows a section through the grill, which extends orthogonal to FIG. 3,

FIG. 5 shows a schematic representation of plate segments of the grill, which can be displaced relative to one another,

FIG. 6 shows another sectioned view of the grill,

FIG. 7 shows an inventive grill according to a second embodiment,

FIG. 8 shows a section through the grill according to FIG. 7,

FIG. 9 shows a schematic representation with plate segments that can be displaced relative to one another,

FIG. 10 shows the grill in a closed state,

FIG. 11 shows a side view of the grill in an open state, and

FIG. 12 shows a side view of the grill in a closed state.

### DESCRIPTION OF THE EMBODIMENTS

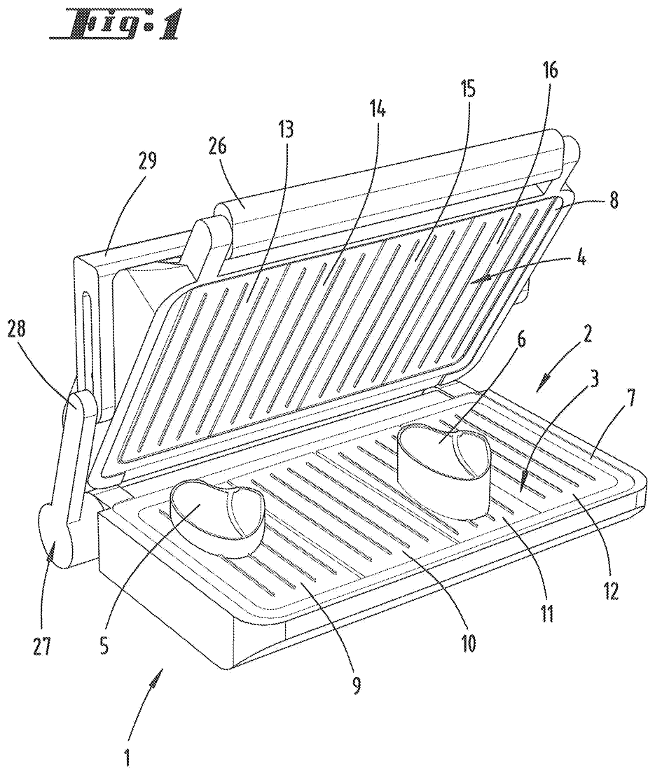

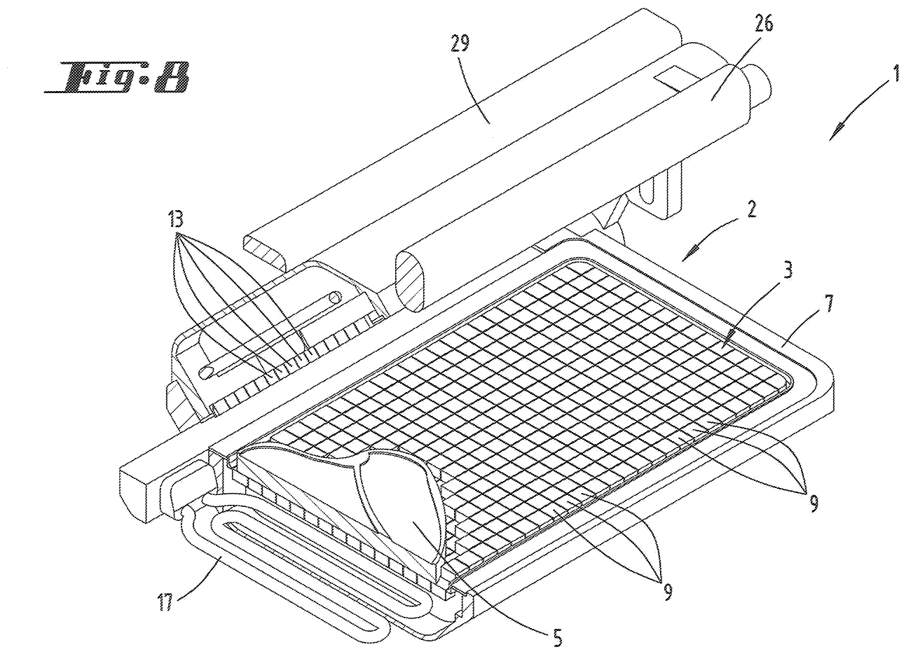

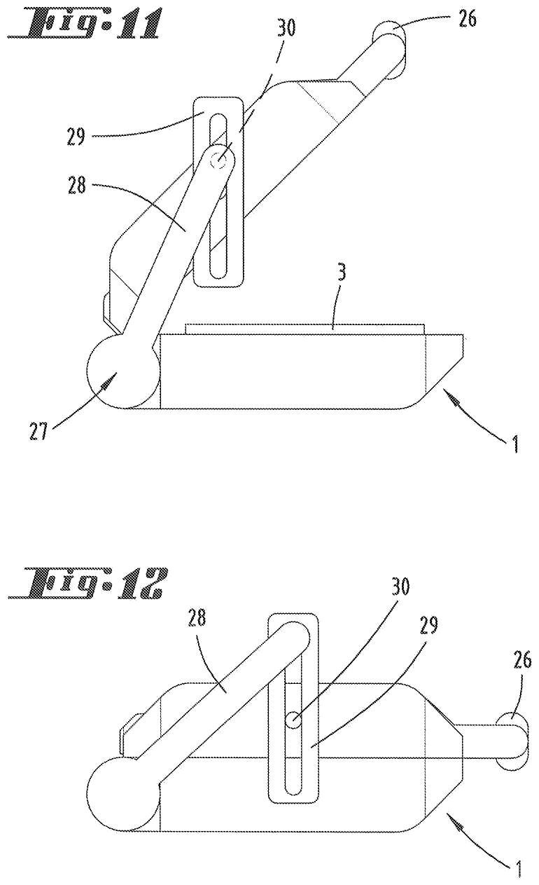

The figures merely show examples of different potential embodiments of an inventive grill, wherein FIGS. 1 to 6 show a first embodiment and FIGS. 7 to 12 show a second embodiment. Other inventive embodiments are naturally also conceivable, wherein the chosen selection should not be interpreted in a restrictive sense.

The grill 1 illustrated in FIG. 1 comprises two opposite grill plates 3, 4. Each of the grill plates 3, 4 is held in a plate base 7, 8, wherein the plate bases 7, 8 can be displaced relative to one another by means of a mechanism with a hinge 27. The hinge 27 comprises a lever 28 that engages into a guide 29 held on an opposite grill plate 4. A guide element 30 of the grill plate 4 likewise engages into this guide 29. The hinge mechanism allows a motion of the upper grill plate 4 relative to two different rotational axes such that the upper grill plate 4 not only can be pivoted relative to the lower grill plate 3, but also linearly displaced. The two opposite grill plates 3, 4 define a grilling space 2, into which grillables 5, 6 are introduced, between one another. In this case, two grillables 5, 6 are located within the grilling space 2, wherein a first grillable 5 has a different height than a second grillable 6.

The grill plates 3, 4 comprise multiple plate segments 9 to 16, wherein the lower grill plate 3 comprises four plate segments 9 to 12 and the upper grill plate 4 likewise comprises four plate segments 13 to 16. The plate segments 9 to 12 of the lower grill plate 3 are arranged stationary relative to the associated plate base 7 whereas the plate segments 13 to 16 of the upper grill plate 4 can be displaced relative to their plate base 8, namely into the plate base 8, wherein this corresponds, for example, to a displacement motion orthogonal to the plate plane of the plate base 8. The upper grill plate 4 can be displaced relative to the lower grill plate 3 in that a user takes hold of a handle 26 arranged on the upper grill plate 4 and displaces the upper grill plate 4 into a desired position.

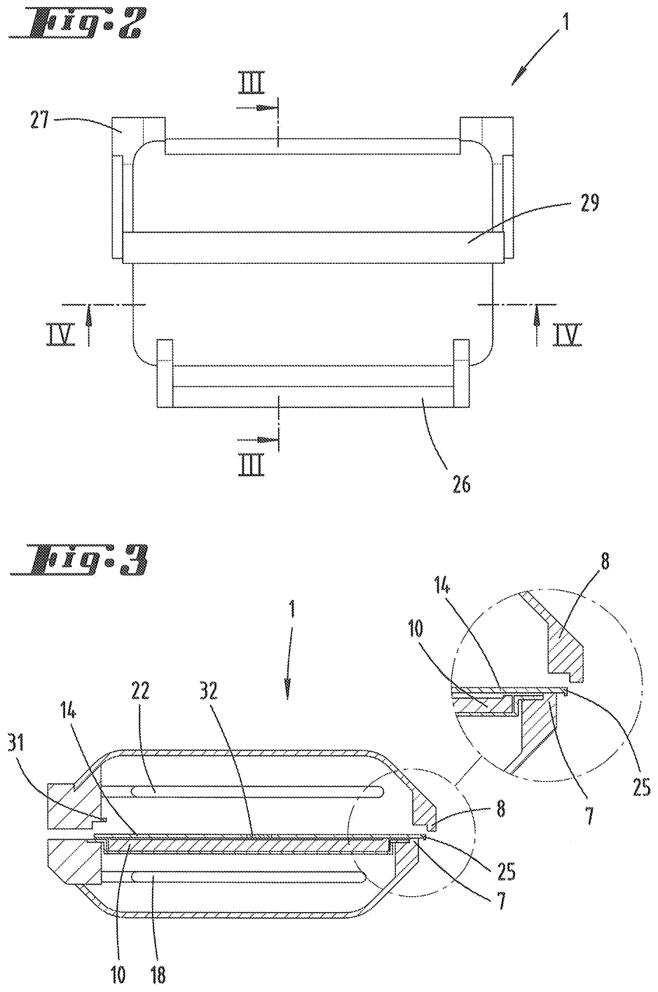

FIG. 2 shows a top view of the grill 1 illustrated in FIG. 1. According to this figure, the handle 26 protrudes over the contour of the grill 1 such that the user cannot come in contact, for example, with the upper grill plate 4 when taking hold of the handle 26 and also does not suffer any heat exposure when opening the grilling space 2.

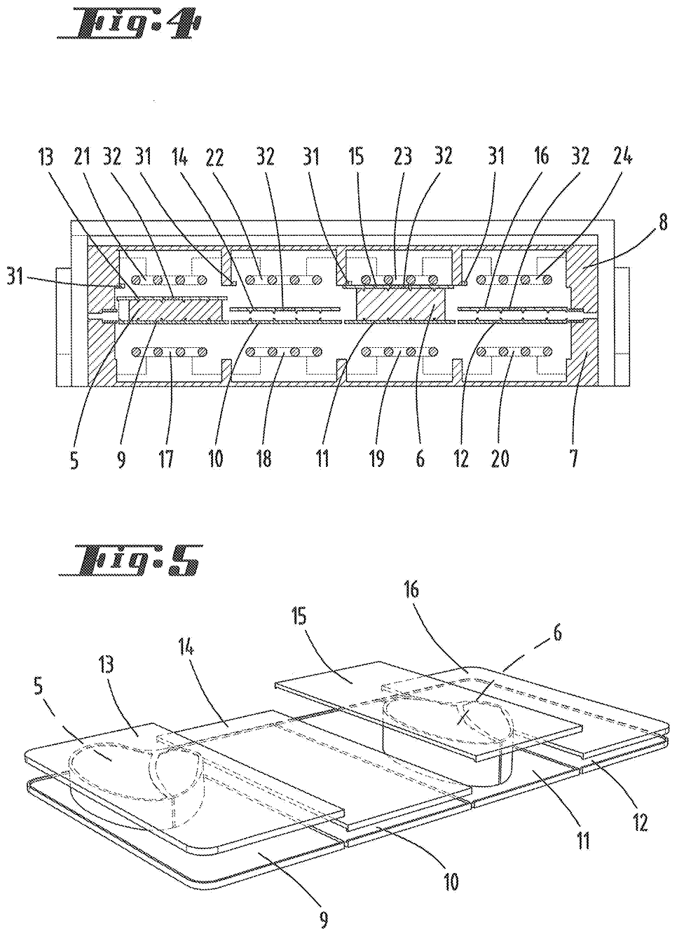

FIG. 3 shows a section through the grill 1 along the line of section III indicated in FIG. 2. The grill 1 is sectioned in a vertical plane that intersects the opposite plate segments 10 and 14 of the lower and upper grill plates 3, 4. The plate base 8 of the upper grill plate 4 and therefore also the plate segment 14 of the upper grill plate 4 respectively are longer than the lower plate base 7 and the lower plate segment 10. Consequently, an edge region 25 of the upper plate segment 14 protrudes over the lower plate base 7 such that liquid, which is located in the grilling space 2 and produced by the grillables 5, 6 located therein, can be respectively drained off or flow out of the grilling space 2. A not-shown liquid collection device, e.g. a container placed adjacent to the lower plate base 7, may be provided in order to collect the liquid.

FIG. 4 shows a section through the grill 1 along the line IV indicated in FIG. 2. The grilling space 2 is loaded with two grillables 5, 6 that have different heights, wherein a first grillable 5 lies between the respective plate segments 9 and 13 of the lower and the upper grilling plate 3, 4 and a second, thicker grillable 6 lies between the respective plate segments 11 and 15 of the lower and the upper grill plate 3, 4. The other plate segments 10, 12, 14, 16 are not in contact with any grillables. A separate heating device 17 to 24 is assigned to each of the plate segments 9 to 16. Each of the heating devices 17 to 24 can be controlled independently of the other heating devices 17 to 24. In this case, the heating devices 17 to 24 are realized, for example, in the form of heating resistors. The grill 1 comprises a control device that is designed for controlling the heating devices 17 to 24. In FIG. 4, the plate segments 13 and 15 of the upper grill plate 4 are displaced in accordance with the thicknesses of the grillables 5, 6 lying on the grill. The plate base 8 assigned to the plate segments 13 to 16 of the upper grill plate 4 is essentially realized in a cup-shaped manner such that the plate segments 13 to 16 can be displaced into the upper plate base 8. On the other hand, the plate segments 9 to 12 of the lower grill plate 3 are arranged stationary on the lower plate base 7 and not displaced when they come in contact with the respective grillables 5, 6. The distance between the opposite plate segments 9 and 13 corresponds to the height of the grillable 5. The distance between the opposite plate segments 11 and 15 corresponds to the height of the grillable 6 lying between these plate segments. In this case, the upper plate segments 13 to 16 are supported on the plate base 8, for example, in a slidable manner such that a vertical displacement relative to the plate base 8 occurs when the plate segments 13 to 16 come in contact with the grillables 5, 6. A sensor system, which detects the presence of grillables 5, 6 and controls the heating devices 17, 19, 21, 23 assigned to the respective plate segments 9, 11, 13, 15, preferably is assigned to the upper plate segments 13, 16. For example, a contact sensor 32 assigned to the plate segments 9, 11, 13, 15 can detect that a force is exerted upon the plate segments 9, 11, 13, 15. A sensor 31 can be assigned to the plate segment 9, 11, 13, 15 to detect a displacement or a state of displacement of the respective plate segment. Subsequently, the control device determines that a grillable 5, 6 rests against the respective plate segments 9, 13 and 11, 15 and activates the heating devices 17, 19, 21, 23 assigned to the plate segments 9, 11, 13, 15. It would be possible that another sensor system, e.g. a weighing device assigned to the lower plate segments 9 to 12, measures the weight of the grillables 5, 6 and controls a temperature and/or heating time or other parameters of the cooking process accordingly. Due to the displaceability of the plate segments 13 to 16 of the upper grill plate 4, the respective plate segments 9, 13 or 10, 14 or 11, 15 or 12, 16 always rest against both sides of grillables 5, 6 arranged between these plate segments. This prevents a first grillable 5, which has a smaller height than a second grillable 6, from coming in contact with the upper grill plate 4. In fact, the vertical position of the upper plate segments 13 to 16 is adapted to the height of the respective grillable 5, 6 such that a homogenous cooking result for grillables 5, 6 with different heights can be ensured.

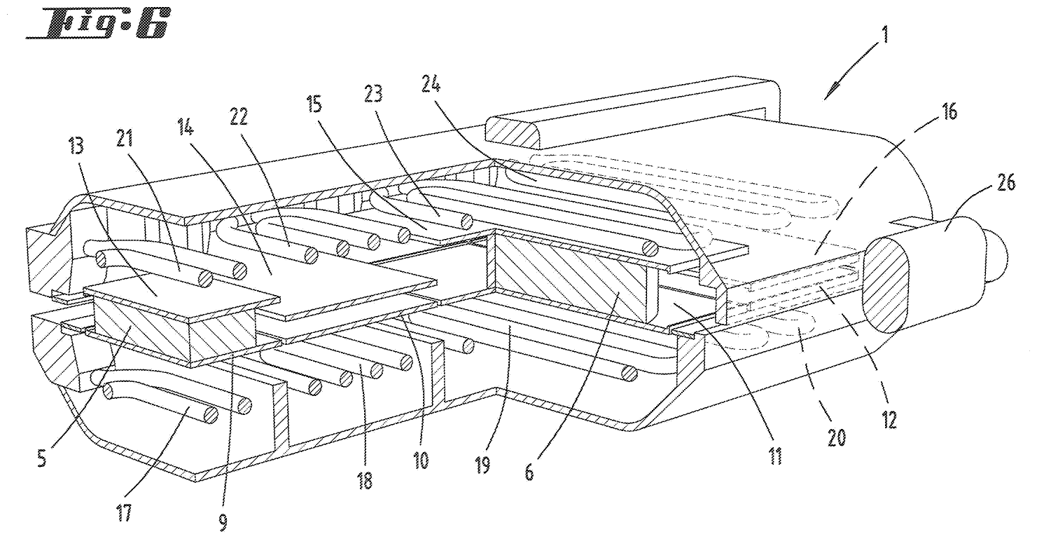

FIG. 5 shows a schematic representation of the segmented grill plates 3, 4, in which the horizontal planes of the displaced upper plate segments 13, 15 are visible.

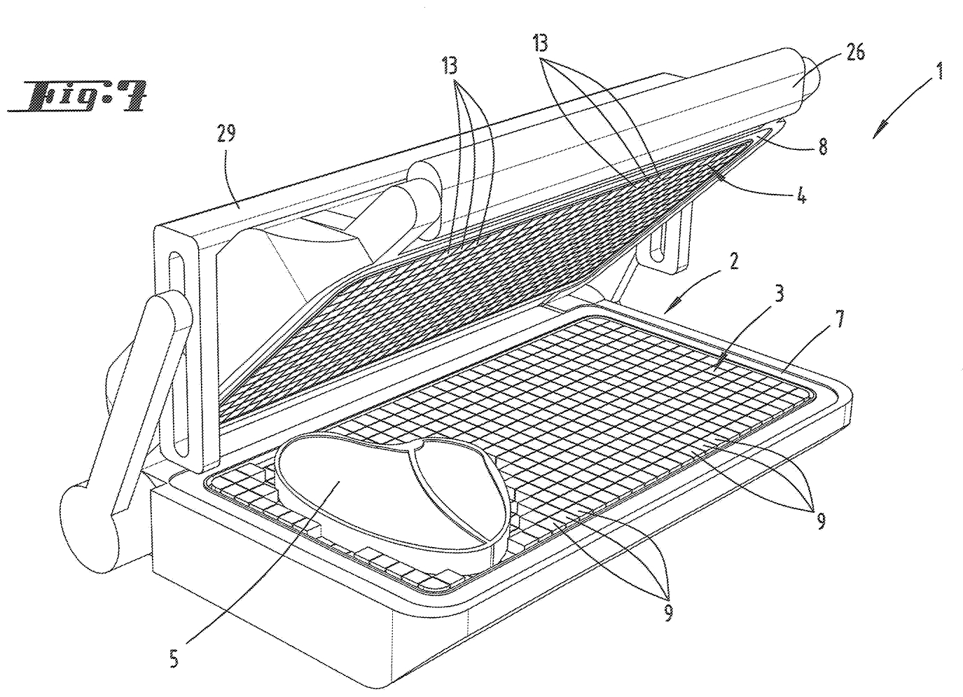

FIG. 6 shows a three-dimensional section through the grill 1 that further elucidate the structure of the grill 1. This figure shows the different horizontal planes of the plate segments 9 to 16 of the two grill plates 3, 4, as well as the heating devices 17 to 24 assigned to the plate segments 9 to 16. As an alternative to the embodiment shown, it would naturally also be possible that one heating device 17 to 24 simultaneously heats multiple plate segments 9 to 16 or that multiple heating devices 17 to 24 heat a certain plate segment 9 to 16.

FIGS. 7 to 11 show a second inventive grill 1, in which both grill plates 3, 4 respectively comprise a very large number of plate segments 9 and 13. In this case, the plate segments 9, 13 are significantly smaller than the plate segments 9 to 16 in the embodiment described above with reference to FIGS. 1 to 6. Due to the smaller surface of the individual plate segments 9, 13, the contour of a grillable 5 located within the grilling space 2 can be reproduced much more accurately such that the surface of the grill plates 3, 4 can optionally be used in a more space-saving manner and adapted to many different surface areas of grillables 5. In this case, all individual plate segments 9, 13 of the lower grill plate 3, as well as of the upper grill plate 4, can be displaced relative to the respectively associated plate base 7, 8. The displaceability can be achieved by pressing the grillable 5 against the respective plate segments 9, 13, wherein a spring element preferably is assigned to the plate segments 9 of the lower plate base 7 and displaces the unstressed plate segments 9 back into a starting position that corresponds to a position, in which these plate segments are displaced in the direction of the upper plate base 8. When a grillable 5 is placed on the plate segments, the weight of the grillable 5 or the weight of the opposite plate segments 13 respectively can overcome the restoring force of the spring element such that these plate segments are displaced into the lower plate base 7. The plate segments 13 of the upper grill plate 4 preferably can be displaced in the direction of the lower grill plate 3 at least in an assistive manner by the weight applied to the plate segments 13. A respective spring element may alternatively or additionally also be assigned to the upper plate segments 13, wherein said spring element positions these plate segments such that they protrude out of the cup-shaped plate base 8.

FIG. 8 shows a section through the grill 1 according to FIG. 7. This figure shows a heating device 17 that is assigned to the plate segments 9. The upper grill plate 4 may analogously comprise a heating device 21. In this example, a common heating device 17 is assigned to a plurality of plate segments 9. However, it would also be possible to assign a separate heating device 17 to each plate segment 9. A control device of the grill 1 may be designed, for example, for detecting a contact between the plate segments 9, 13 and a grillable 5 and for activating a heating device 17, 21 at the corresponding location.

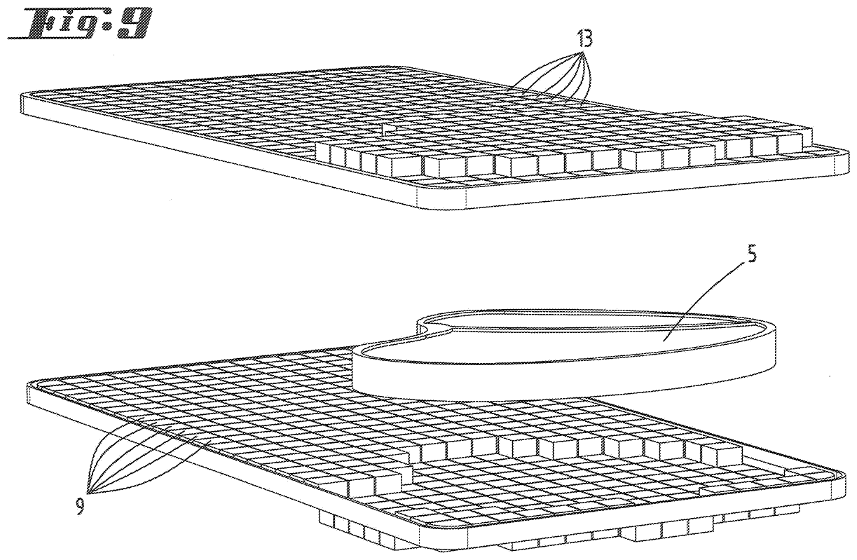

FIG. 9 shows a schematic representation of the grill plates 3, 4, the plate segments 9, 13 of which are adapted to a shape of a grillable 5, particularly its outer contour and thickness. The smaller the contact surface of the plate segments 9, 13, the more accurately the contour of the grillable 5 can be reproduced.

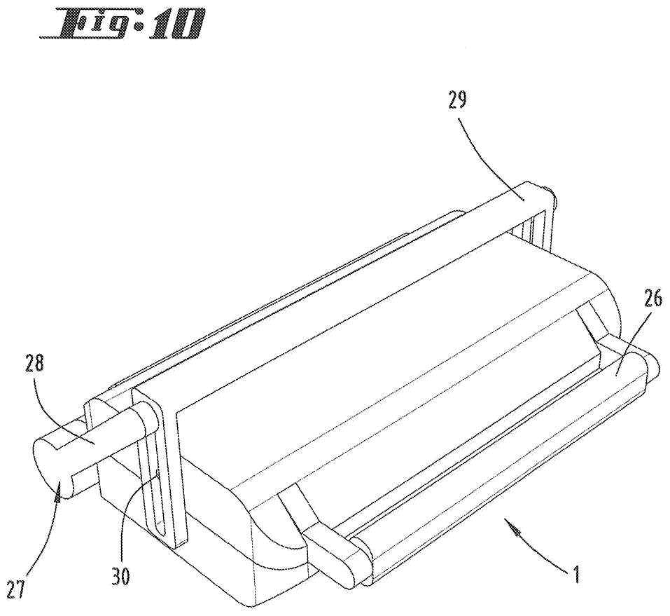

FIGS. 10 to 12 ultimately show different views of the grill 1 in the closed state, as well as in the open state. The grill 1 comprises two plate bases 7, 8 that end flush with one another in this example. According to this embodiment, a not-shown opening may be provided, for example, on the lower plate base 7 in order to drain off liquid from the grilling space 2. Analogous to the first embodiment according to FIGS. 1 to 6, the two plate bases 7, 8 furthermore are connected to one another by means of a hinge mechanism that allows a mobility of the upper grill plate 4 relative to the lower grill plate 3.

### REFERENCE LIST

1 Grill
2 Grilling space
3 Grill plate
4 Grill plate
5 Grillable
6 Grillable
7 Plate base
8 Plate base
9 Plate segment
10 Plate segment
11 Plate segment
12 Plate segment
13 Plate segment
14 Plate segment
15 Plate segment
16 Plate segment
17 Heating device
18 Heating device
19 Heating device
20 Heating device
21 Heating device
22 Heating device
23 Heating device
24 Heating device
25 Edge region
26 Handle
27 Hinge
28 Lever
29 Guide
30 Guide element
31 Displacement sensor
32 Contact sensor

What is claimed is:

1. An electric grill comprising:
two grill plates having plate surfaces that lie opposite to each other and jointly define a grilling space, the grill plates comprising a first grill plate for supporting grillables and a second grill plate that is configured to be displaced relative to the first grill plate,
a plate base assigned to each grill plate and being configured for holding the respective grill plate,
wherein at least one of the grill plates comprises multiple plate segments, which are displaceably held on the respective plate base and are configured to be automatically displaced relative to each other and to the respective plate base depending on a size and/or shape of a grillable introduced into the grilling space.

2. The electric grill according to claim 1, wherein the plate base is cup-shaped, and wherein at least one of the plate segments is configured to be at least partially displaced into the plate base.

3. The electric grill according to claim 1, further comprising a resetting element assigned to at least one of the plate segments, the resetting element elastically supporting the at least one plate segment on the plate base.

4. The electric grill according to claim 1, wherein a plate segment of the second grill plate is configured to be displaced relative to the respective plate base due to a gravitational force acting upon the plate segment.

5. The electric grill according to claim 1, wherein at least one of the plate segments provide a contact surface for grillables and has a surface area that amounts to 1 mm² to 1000 cm².

6. The electric grill according to claim 1, wherein one of the grill plates comprises between two and one hundred plate segments.

7. The electric grill according to claim 1, wherein one of the grill plates comprises at least two plate segments, wherein a separate heating device is assigned to each of the two plate segments, and wherein the heating devices are configured to be controlled independently of one another with respect to an operating state and/or a heating power and/or a heating time.

8. The electric grill according to claim 1, further comprising a sensor assigned to at least one of the plate segments, and being configured for detecting a displacement or a state of displacement of the at least one plate segment or for detecting the presence of grillables on a contact surface of the at least one plate segment.

9. The electric grill according to claim 8, further comprising a control device that is designed for controlling a heating device assigned to at least one of the plate segments in dependence on a detection result of the sensor.

10. The electric grill according to claim 1, wherein one of the grill plates protrudes over the other of the grill plates and/or plate base with an edge region in a closed state of the grilling space such that liquid present in the grilling space can drain off.
